(19) United States
(12) Patent Application Publication
(10) Pub. No.: US 2007/0245040 A1
(43) Pub. Date: Oct. 18, 2007

(54) DATA STORING

(76) Inventor: Peter F. Acsadi, Parkrow, MD (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 11/691,747

(22) Filed: Mar. 27, 2007

Related U.S. Application Data
(60) Provisional application No. 60/744,878, filed on Apr. 14, 2006.

(51) Int. Cl. G06F 3/00

(52) U.S. Cl. 710/20

(57) ABSTRACT

In one aspect, a method to store data includes transferring a configuration file including a state machine and data to a programmable logic device (PLD). Transferring the configuration file includes programming the state machine based on the state machine configuration and transferring the data from the PLD to a memory connected to the PLD using the state machine.

### RELATED APPLICATIONS

This application claims priority to provisional application Ser. No. 60/744,878, entitled “Data Storing,” filed Apr. 14, 2006, which is incorporated herein in its entirety.

### BACKGROUND

Typically, circuit boards that include field-programmable gate arrays (FPGA) devices have associated memory, such as flash memory, connected to the FPGA devices. In some situations, it is desirable to change data stored in the associated memory with new data. Generally, there is no means to access the associated memory except through the IC chip.

The Joint Test Action Group (JTAG) and Institute for Electrical and Electronics Engineers (IEEE) established a common test access port (TAP) and boundary-scan architecture for digital ICs chips commonly known as a JTAG interface. Boundary scan test circuitry is an independent subsystem within the FPGA device, which accesses functional pins through a boundary scan shift register. The boundary scan shift register is controlled through the JTAG interface on the FPGA device by a TAP controller. Though not originally designed for accessing memory external to the FPGA device, the JTAG interface may be used to write or read data into or from the associated memory.

### SUMMARY

In one aspect, a method to store data includes transferring a configuration file including a state machine configuration and data to a programmable logic device (PLD). Transferring the configuration file includes programming a state machine based on the state machine configuration and transferring the data from the PLD to a memory connected to the PLD using the state machine.

In another aspect, an apparatus to store data includes circuitry to transfer a configuration file including a state machine and data to programmable logic device (PLD). The circuitry to transfer the configuration file includes circuitry to program a state machine based on the state machine configuration. The apparatus also includes circuitry to transfer the data from the PLD to a memory connected to the PLD using the state machine.

In a further aspect, an apparatus to store data includes circuitry to transfer a configuration file including a state machine and data to programmable logic device (PLD). The circuitry to transfer the configuration file includes circuitry to program a state machine based on the state machine configuration. The apparatus also includes circuitry to transfer the data from the PLD to a memory connected to the PLD using the state machine.

In a still further aspect, a method to store data includes transferring a configuration file including a state machine and data to a field-programmable gate array (FPGA) device though an interface connected to the FPGA device. Transferring the configuration file includes programming the state machine in the FPGA device. The method also includes transferring the data independent of the interface from the FPGA IC to a flash memory external to the FPGA device using the state machine.

### DESCRIPTION OF THE DRAWINGS

FIG. 1 is a block diagram of a data storing system.

FIG. 2 is a flowchart of an example of a process to store data.

FIG. 3 is a flowchart of an example of a process to perform an initialization.

FIG. 4 is an example of a data structure.

FIG. 5 is a block diagram of the data storing system with a state machine.

FIG. 6 is a flowchart of an example of a process used by the state machine of FIG. 5.

FIG. 7 is another example of a data storing system.

FIG. 8 is a block diagram of a computer system on which the process of FIG. 2 may be implemented.

### DETAILED DESCRIPTION

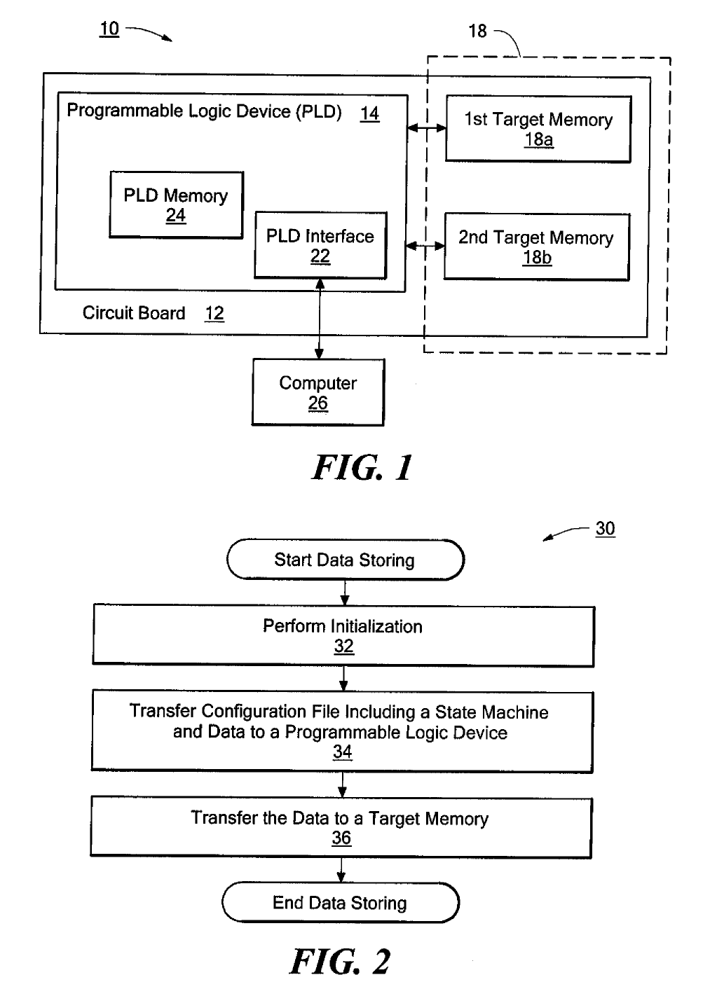

Referring to FIG. 1, a data storing system (DSS) 10 includes a circuit board 12 having a programmable logic device (PLD) 14 and a target memory 18 of an integrated circuit (IC) chip (not shown). The PLD 14 includes a PLD interface 22 and a PLD memory 24. In this embodiment, the target memory 18 includes a first target memory device 18a and a second target memory device 18b; however, in other embodiments, the target memory 18 may include one or more memory devices.

The DSS 10 also includes a computer 26 connected to the PLD 14 through the PLD interface 22. In one embodiment, the integrated circuit 14 is a programmable logic device such as a field-programmable gate array (FPGA), the target memory 18 is flash memory and the PLD interface 22 is a JTAG interface.

Prior attempts to improve access to the target memory 18 included improving or augmenting a test access port (TAP). In these prior attempts, an improved TAP architecture is downloaded into the PLD 14 through the PLD interface 22. Once the improved TAP architecture is formed, a higher bandwidth path exists from the computer 26 (a data source), through the PLD interface 22 to the target memory 18. Thus, the data is transferred directly from the computer 26 to the target memory 18 through the PLD 14.

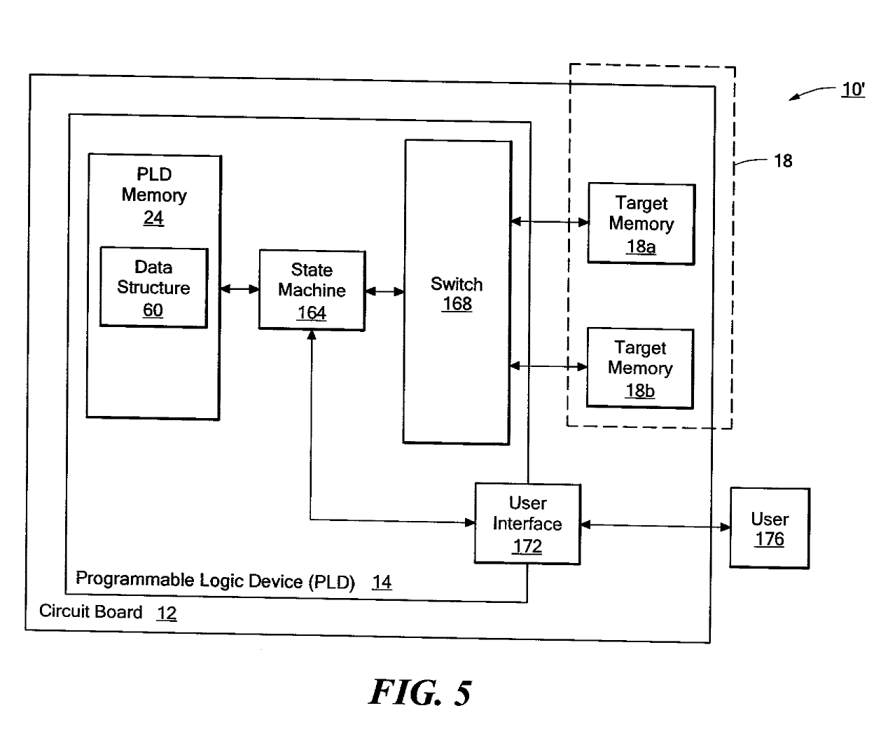

As will be shown below, unlike previous methods for writing data in the target memory 18, the DSS 10 stores a state machine 164 (FIG. 5) and data in the PLD 14 through the PLD interface 22. After the state machine 164 (FIG. 5) and the data are stored in the PLD 14, the state machine controls transmitting the data from the PLD 14 to the target memory 18 without further reliance on the interface 22 or the computer 26.

Referring to FIG. 2, a process 30 is an example of a process to store data in the target memory 18. Process 30 performs an initialization (32). Process 30 transfers the configuration file to the PLD 14 (34). For example, the configuration file is sent from the computer 26 to the PLD 14 through the PLD interface 22. As will be shown below, the configuration file includes a state machine (e.g., the state machine 164 (FIG. 5)) and data (a data structure 60 (FIG. 5)). Process 30 transfers the data to the target memory 18 (36).

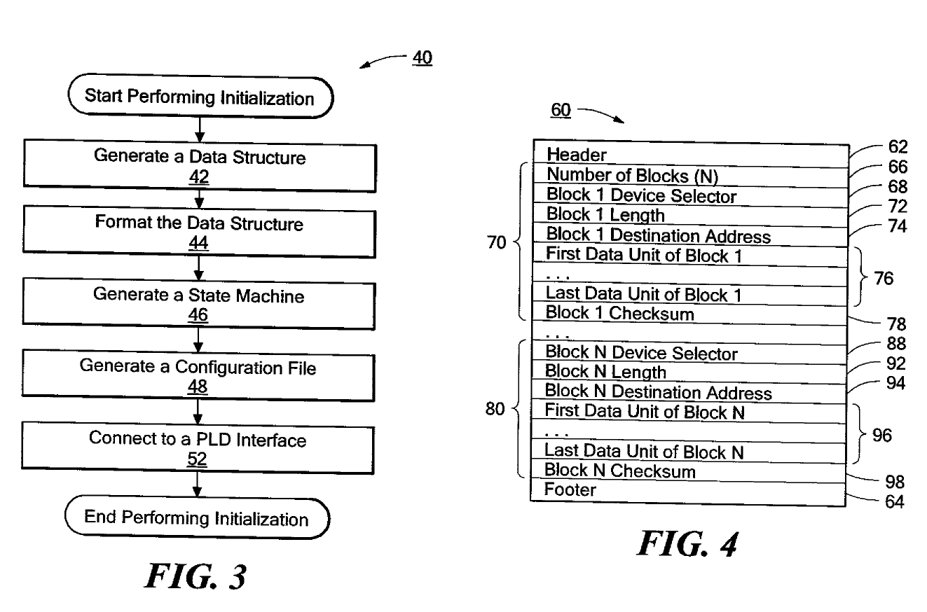

Referring to FIGS. 3 and 4, in one example, the initialization processing block 32 (FIG. 2) may be performed by a process 40. Process 40 generates a data structure (42). The data structure includes fields for defining where, how and what data will be stored in the target memory 18. For example, referring to FIG. 4, a data structure 60 includes a header field 62, a footer field 64 and a number of blocks field 66. Since the data structure 60 is initially loaded into the PLD memory 24, the data structure is formatted to the PLD memory 24 by a formatter (see block 44). The header field 62 and footer field 64 enable the data structure 60 to be formatted properly to be stored in the PLD memory 24. The data structure 60 may contain one or more blocks limited only by the length of the blocks, the size of the PLD memory 24 and the bits allocated to the number of blocks. In one example, the PLD memory 24 is a read-only memory (ROM). In another example, the PLD memory is a static random-access memory (SRAM).

The number of blocks field 66 indicates the number of blocks, N, of data that will be transferred to the target memory 18. A block includes data elements, which are intended to occupy consecutive memory locations in the target memory 18.

The data structure 60 also includes a series of fields specific to each block of data. For example, a block 1 (i.e., a first block of N blocks of data) includes block 1 fields 70 associated with block 1 data. The block 1 fields 70 include a block 1 device selector field 68, a block 1 length field 72, a block 1 destination address field 74, block l data fields 76 and a block 1 checksum field 78.

The block 1 device selector field 68 designates which target memory device will receive the data block, for example, either the target memory device 18a or the target memory device 18b. The block 1 length field 72 indicates the length of block 1. The block 1 destination address field 74 indicates the destination address in the target memory 18 where the data will begin to be stored. The block 1 data fields 76 include the data to be stored in the target memory 18. The block 1 checksum field 78 includes an associated checksum value for block 1 used to validate that the data in block 1 has been properly transmitted to the target memory 18.

Likewise the remaining N blocks have corresponding fields to block 1 fields 70. For example, the last block, block N, has corresponding N block fields 80. The N block fields 80 include a block N device selector field 88, a block N length field 92, a block N destination address 94, block N data fields 96 and a block N checksum field 98.

Process 40 formats the data structure (44). In one example, the formatter is a FPGA ROM tool, the PLD memory 24 is a ROM and the PLD 14 is an FPGA chip. The FPGA ROM tool processes the data structure 60 so that the entries in the data structure between the header 62 and the footer 64 are synthesized into the ROM format. The width of the entries in the data structure 60 is the same width as the ROM. For example, fields, such as the block N destination address field 94 or the block N length field 92, may require more bits than the ROM width, in which case these fields are stored in multiple consecutive locations.

Process 40 generates a state machine (44). The state machine includes rules for programming the state machine 164 on the PLD 14. The state machine is configured to transfer data to the target memory 18 using protocols specific to the target memory.

Referring to FIGS. 3 and 5, process 40 generates a configuration file (48). For example, the data structure 60 and the state machine are included in the configuration file. In one example, an FPGA ROM synthesis tool merges the formatted ROM data structure 60 and the state machine into an FPGA configuration file. The configuration file also includes the functional configuration of the PLD 14. For example, the configuration file includes interactions of the state machine once stored on the IC chip with other components on the PLD 14. For example, FIG. 5 depicts a DSS 10′ after the state machine 164 and the data structure 60 have been loaded on to the PLD 14. The PLD 14 also includes a switch 168 and a user interface 172. The configuration file includes the configuration of the PLD memory 24, the state machine 164, the switch 168 and the user interface 172e and the connections between each of these components.

In this example, the state machine 164 transfers the data in blocks through the switch 168 to one of the devices in target memory 18 (e.g., the target memory device 18a or the target memory device 18b) in accordance with the data structure 60 (e.g., block 1 device selector field 68, block N device selector field 88 and so forth).

In some examples, the state machine 164 is connected to a user interface 172 interfacing with a user 176. The user interface 172 may be a unidirectional connection from the user 176 to the PLD 14, a unidirectional connection from the PLD 14 to the user 176 or a bidirectional connection direction between the PLD 14 and the user 176. In one example, the user interface 172 may be a simple binary signal driving an indicator (e.g., a light emitting diode). In another example, the user interface 172 may be driven by an open or short source, a custom or standard serial or parallel interface, implemented in part on the FPGA, depending on the resources available on the circuit board.

The user interface 172 may indicate whether the state machine has been successfully loaded onto the IC chip. The user interface 172 may also indicate that the data has been successfully loaded in the target memory 18. In other examples, the user interface 172 allows a user to perform diagnostics within the PLD 14, the target memory 18 or any combination thereof The diagnostics may include “peek and poke” functions to determine if the DSS 10 is functioning properly.

Process 40 connects to a PLD interface (52). For example, the computer 26 (FIG. 1) is connected to the PLD interface 22 (FIG. 1).

In one example, the processing block 34 (FIG. 2) includes transferring the configuration file including the state machine file and the data structure 60 to the PLD 14. The state machine 164 and the data structure 60 are stored in the PLD 14 in accordance with the configuration file. For example, the data structure 60 is stored in the PLD memory 24.

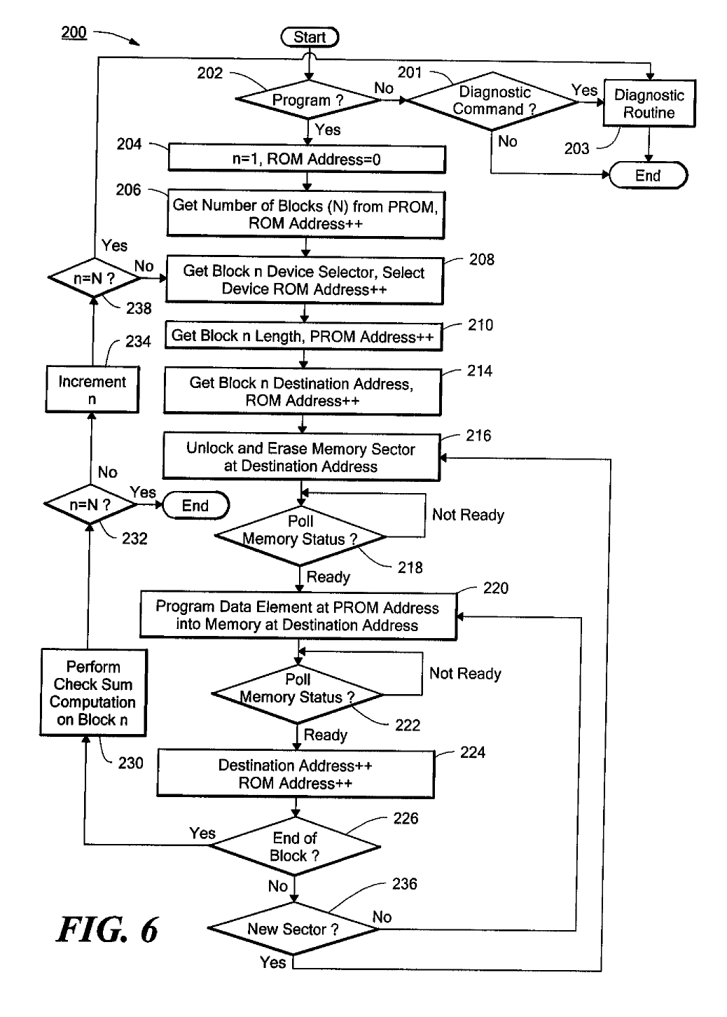

Referring to FIG. 6 is one example of implementing processing block 36 (FIG. 2). For example, the state machine 164 uses a process 200 to transfer data from the PLD memory 24 (e.g., a ROM) to the target memory 18. In process 200, the user interface 172 (FIG. 5) is implemented as a diagnostic interface.

Process 200 determines whether to program the target memory 18 (i.e., transfer data from the PLD memory 24 to the target memory 18) (202). If process 200 determines not to program the target memory 18, process 200 determines if a diagnostic command is received (201). For example, the diagnostic command is received by the user 176 through the user interface 172. If the diagnostic command is received, process 200 performs a diagnostic (203). For example, the diagnostic is performed on the target memory 18. In another example, the diagnostic is performed on the PLD memory 24.

If process 200 determines to program the target memory 18, process 200 goes to the first data block (n=1) and the first address of the PLD memory 24 (204). Process 200 retrieves the number of blocks N from the PLD memory 24 address (206). For example, the state machine 164 retrieves the number of blocks, N, from an entry in the number of blocks field 66.

Process 200 retrieves the block device selector for block n and selects the device (208). For example, the state machine 164 retrieves the device selected from an entry in the Block 1 device selector field 68. If the entry designated the target memory device 18a, the state machine activates the switch 168 to establish a connection between PLD 14 and the target memory 18a. If the entry designated the target memory device 18b, the state machine activates the switch 168 to establish a connection between PLD 14 and the target memory 18b.

Process 200 retrieves block n length (210). For example, for block 1, the state machine 164 retrieves the block n length from an entry in the Block 1 length field 72. Process 200 retrieves block n destination address (214). For example, or block 1, the state machine 164 retrieves the block n destination address from an entry in the Block 1 destination address field 174.

Process 200 unlocks and erases memory sector at block n destination address (216). For example, the state machine 164 sends commands (e.g., command signals) to the target memory device 18a or 18b selected by the device selector and unlocks and erases the memory sector at the block n destination address of the target memory device.

Process 200 polls memory until memory is available (218). For example, the state machine 164 checks the selected target memory device 18a or 18b until it is available. Process 200 programs a data element at the ROM address into memory at destination address (220). For example, the state machine 164 programs the data element from the block 1 data fields 76 to the destination address in the target memory device 18a or 18b.

Process 200 polls memory status until it is available (222). For example, the state machine 164 polls the target memory device 18a or 18b until it is available. Process 200 increments to the next destination address and to the next ROM address (224).

Process 200 determines if it is the end of block n (226). For example, state machine 164 determines that the block 1 is complete by using the block 1 length. If process 200 determines it is not an end of the block, process 200 determines if it is a new sector (236). If process 200 determines it is a new sector, process 200 unlocks and erases memory sector at destination address for the next sector (216). If process 200 determines, it is not a new sector, programs the next data element (220).

If process 200 determines it is at an end of the block, performs a checksum calculation on block n (230). Process 200 determines if n equal N (232). If n equals N, process 200 ends. If n does not equal N, process 200 increments n (234). Process 200 determines if n is greater than N (238). If n is not greater than N, process 200 retrieves block n Device selector (208). If n is greater than N, process 200 performs a diagnostic (203).

In other examples, process 200 may be modified so that the state machine 164 automatically (i.e., without user intervention) transfers the data to the target memory 18 after the state machine is loaded into the PLD 14.

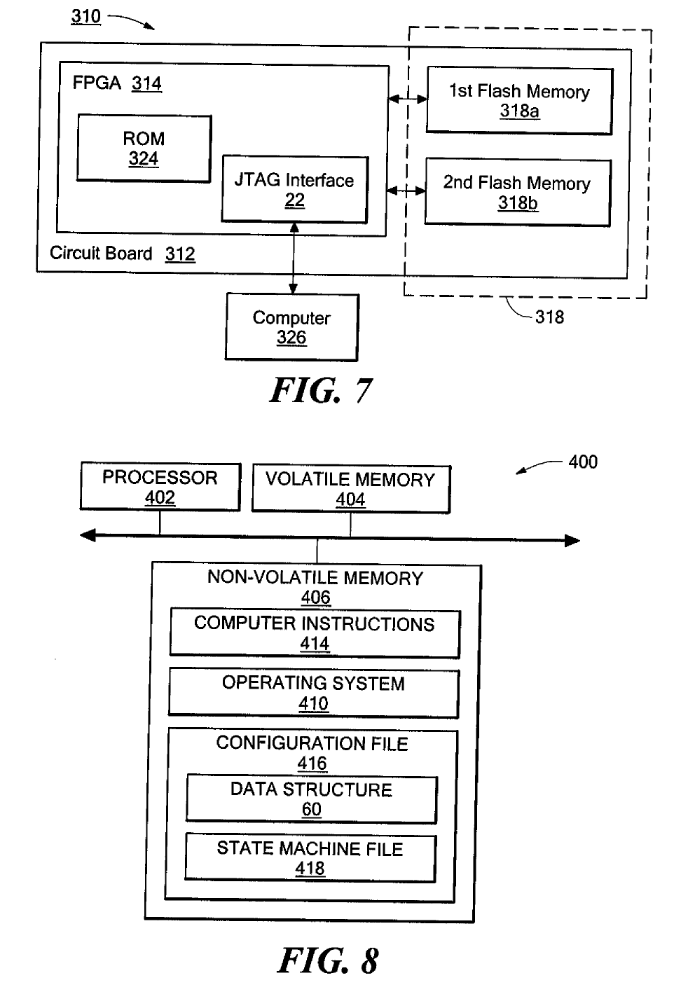

Referring to FIG. 7, in one example of a data storing system, a DSS 310 includes a circuit board 312 having an FPGA device 314 and a flash memory 318, including a first flash memory device 318a and a second flash memory device 318b, connected to the FPGA device. The FPGA device 314 includes a STAG interface 322 and a ROM 324.

The DSS 310 also includes a computer 326 connected to the FPGA device 314 through the JTAG interface 322. In this example, a user transfers a configuration file, including data and a state machine configuration, from the computer 326 to the FPGA device 314 through the JTAG interface 318. The data is stored in the ROM 324 and a state machine is programmed in the FPGA device 314. Data is transferred from the ROM 324 by the state machine to one or more of the memory devices 318a, 318b.

FIG. 8 shows an example of a computer 400 for which one or more blocks of process 30 may be performed. Computer 400 includes a processor 402, a volatile memory 404 and a non-volatile memory 406 (e.g., a hard disk). Non-volatile memory 406 stores operating system 410, a configuration file 416 having the data structure 60 and a state machine file 418 including the state machine 164, and computer instructions 414, which are executed by processor 402 out of volatile memory 404 to execute all or portions of process 30.

Process 30 is not limited to use with the hardware and software of FIG. 8; it may find applicability in any manual, visual or computing or processing environment and with any type of medium or machine that is capable of running the models or a computer program. Process 30 may be implemented in hardware, software, or a combination of the two. Process 30 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform the integrated mission module and to generate output information.

Process 30 may be implemented, at least in part, via any computer program product, e.g., in a machine-readable storage device, for execution by, or to control the operation of, data processing apparatus, e.g., a programmable processor, a computer, or multiple computers. Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform the integrated mission module.

Process 30 may be performed by one or more programmable processors executing one or more computer programs to perform the functions of the system. All or part of the system may be implemented as, special purpose logic circuitry, e.g., an FPGA (field-programmable gate array) and/or an ASIC (application-specific integrated circuit).

The processes described herein are not limited to the specific embodiments described herein. For example, the processes are not limited to the specific processing order of FIGS. 2, 3 and 6. Rather, any of the blocks of FIGS. 2, 3 and 6 may be re-ordered, combined, repeated or removed, performed in series or performed in parallel, as necessary, to achieve the results set forth above. In some examples, processing blocks 44 and 48 in FIG. 3 may be combined so that one synthesis tool may format the data structure 60 and merge the formatted data structure 60 with the state machine file to form the configuration file.

Elements of different embodiments described herein may be combined to form other embodiments not specifically set forth above. Other embodiments not specifically described herein are also within the scope of the following claims.

What is claimed is:

1. A method to store data, comprising:
transferring a configuration file comprising a state machine and data to a programmable logic device (PLD), transferring the configuration file comprises programming the state machine in the PLD; and
transferring the data from the PLD to a memory connected to the PLD using the state machine.

2. The method of claim 1 wherein transferring the configuration file comprises transferring the configuration file to the PLD though a PLD interface connected to the PLD and wherein transferring the data comprises transferring the data independent of the PLD interface.

3. The method of claim 1, further comprising:
connecting a link to the PLD to provide the configuration file; and
disconnecting the link prior to transferring the data from the PLD to the memory.

4. The method of claim 1 wherein transferring the configuration file to a PLD comprises transferring the configuration file to a field-programmable gate array (FPGA) device.

5. The method of claim 1 wherein transferring the configuration file comprises transferring a configuration file comprising a user interface configuration.

6. The method of claim 5 wherein transferring the configuration file comprising the user interface configuration comprises transferring the configuration file comprising the user interface configuration to perform diagnostics on the memory.

7. The method of claim 1 wherein transferring the configuration file comprises transferring the configuration file comprising a switch configuration.

8. The method of claim 1 wherein transferring the configuration file comprises transferring the configuration file through a JTAG interface without modification to the JTAG interface.

9. The method of claim 1 wherein transferring the configuration file comprises transferring the configuration file comprising a data structure, and
wherein the data structure includes the data and a field indicating a location in the memory to store the data.

10. The method of claim 1 wherein transferring the data to a memory external to the PLD comprises transferring the data to a flash memory.

11. The method of claim 1 wherein transferring the data to a memory external to the PLD comprises transferring the data to at least one memory device.

12. An apparatus to store data, comprising:
circuitry to:
transfer a configuration file comprising a state machine and data to programmable logic device (PLD), circuitry to transfer the configuration file includes circuitry to program a state machine based on the state machine configuration; and
transfer the data from the PLD to a memory connected to the PLD using the state machine.

13. The apparatus of claim 12 wherein the circuitry comprises at least one of a processor, a memory, programmable logic and logic gates.

14. The apparatus of claim 12 wherein the circuitry to transfer the configuration file comprises circuitry to transfer the configuration file to the PLD though a PLD interface connected to the PLD and wherein the circuitry to transfer the data comprises circuitry to transfer the data independent of the PLD interface.

15. The apparatus of claim 12, further comprising circuitry to:
connect a link to the PLD to provide the configuration file; and
disconnect the link prior to transferring the data from the PLD to the memory.

16. The apparatus of claim 12 wherein the circuitry to transfer the configuration file to a PLD comprises circuitry to transfer the configuration file to a field-programmable gate array (FPGA) device.

17. The apparatus of claim 12 wherein the circuitry to transfer the configuration file comprises circuitry to transfer a configuration file comprising a user interface configuration.

18. The apparatus of claim 17 wherein circuitry to transfer the configuration file comprising the user interface configuration comprises circuitry to transfer the configuration file comprising the user interface configuration to perform diagnostics on the memory.

19. The apparatus of claim 12 wherein the circuitry to transfer the configuration file comprises circuitry to transfer the configuration file comprising a switch configuration.

20. The apparatus of claim 12 wherein the circuitry to transfer the configuration file comprises circuitry to transfer the configuration file through a JTAG interface without modification to the JTAG interface.

21. The apparatus of claim 12 wherein the circuitry to transfer the configuration file comprises circuitry to transfer the configuration file comprising a data structure, and
wherein the data structure includes the data and a field indicating a location in the memory to store the data.

22. An article comprising a machine-readable medium that stores instructions to store data, the instructions causing a machine to:
transfer a configuration file including a state machine configuration and data to a programmable logic device (PLD), the instructions causing the machine to transfer the configuration file comprises instructions causing the machine to program a state machine based in the PLD; and
transfer the data from the PLD to a memory connected to the PLD using the state machine.

23. The article of claim 22 wherein the instructions causing a machine to transfer the configuration file comprises instructions causing a machine to transfer the configuration file to the PLD though a PLD interface connected to the PLD and wherein the instructions causing a machine to transfer the data comprises instructions causing a machine to transfer the data independent of the PLD interface.

24. The article of claim 22, further comprising instructions causing a machine to:
connect a link to the PLD to provide the configuration file; and
disconnect the link prior to transferring the data from the PLD to the memory.

25. The article of claim 22 wherein the instructions causing a machine to transfer the configuration file to a PLD comprises instructions causing a machine to transfer the configuration file to a field-programmable gate array (FPGA) device.

26. The apparatus of claim 22 wherein the instructions causing a machine to transfer the configuration file comprises instructions causing a machine to transfer a configuration file comprising a user interface configuration.

27. The article of claim 26 wherein instructions causing a machine to transfer the configuration file comprising the user interface configuration comprises instructions causing a machine to transfer the configuration file comprising the user interface configuration to perform diagnostics on the memory.

28. The article of claim 22 wherein the instructions causing a machine to transfer the configuration file comprises instructions causing a machine to transfer the configuration file comprising a switch configuration.

29. The article of claim 22 wherein the instructions causing a machine to transfer the configuration file comprises instructions causing a machine to transfer the configuration file through a JTAG interface without modification to the JTAG interface.

30. The article of claim 22 wherein the instructions causing a machine to transfer the configuration file comprises instructions causing a machine to transfer the configuration file comprising a data structure, and wherein the data structure includes the data and a field indicating a location in the memory to store the data.

31. A method to store data, comprising:
transferring a configuration file including a state machine and data to a field-programmable gate array (FPGA) device though an interface connected to the FPGA device, transferring the configuration file comprises programming the state machine in the FPGA device; and
transferring the data independent of the interface from the FPGA device to a flash memory external to the FPGA device using the state machine.

32. The method of claim 31, further comprising:
connecting a link to the PLD to provide the configuration file; and
disconnecting the link prior to transferring the data from the PLD to the memory.

33. The method of claim 31 wherein transferring the configuration file comprises transferring a configuration file comprising a user interface configuration.

34. The method of claim 33 wherein transferring the configuration file comprising the user interface configuration comprises transferring the configuration file comprising the user interface configuration to perform diagnostics on the memory.

35. The method of claim 31 wherein transferring the configuration file comprises transferring the configuration file comprising a switch configuration.

36. The method of claim 31 wherein transferring the configuration file comprises transferring the configuration file through a JTAG interface without modification to the JTAG interface.

37. The method of claim 31 wherein transferring the configuration file comprises transferring the configuration file comprising a data structure, and
wherein the data structure includes the data and a field indicating a location in the memory to store the data.

38. The method of claim 31 wherein transferring the data to a memory external to the PLD comprises transferring the data to at least one memory device.
